(19) United States
(12) Patent Application Publication
(10) Pub. No.: US 2023/0082630 A1
(43) Pub. Date: Mar. 16, 2023

(54) DATA PROCESSING METHODS, APPARATUSES AND SYSTEMS, MEDIA AND COMPUTER DEVICES

(71) Applicant: SENSETIME INTERNATIONAL PTE. LTD., Singapore (SG)

(72) Inventor: Liyao Yang, Singapore (SG)

(21) Appl. No.: 17/488,998

(22) Filed: Sep. 29, 2021

Related U.S. Application Data
(63) Continuation of application No. PCT/IB2021/058721, filed on Sep. 24, 2021.

(30) Foreign Application Priority Data
Sep. 13, 2021 (SG) 10202110060Y

(51) Int. Cl. G06K 9/62; G06T 7/60; G06T 7/70; A63F 13/53

(52) U.S. Cl. CPC G06K 9/6292; G06T 7/60; G06K 9/6267; G06T 7/70; A63F 13/53; G06T 2207/30242; G06K 2209/21

(57) ABSTRACT

Embodiments of the present disclosure provide a data processing method, apparatus and system, a medium and a computer device. By detecting a bounding box of a stack from a top view image of the stack, first size information of the stack is determined based on the bounding box of the stack; and stacking state information of the stack is determined based on the distinction between the first size information and second size information of one of the at least one object.

### CROSS-REFERENCE TO RELATED APPLICATION

The present application is a continuation of International Application No. PCT/IB2021/058721, filed on Sep. 24, 2021, which claims a priority of the Singaporean patent application No. 10202110060Y filed on Sep. 13, 2021, which is incorporated herein by reference in its entirety.

### TECHNICAL FIELD

The present disclosure relates to the field of computer vision technology, and in particular, to a data processing method, apparatus and system, a medium and a computer device.

### BACKGROUND

In practical applications, it is often necessary to process a stack, for example, to identify categories of objects for forming the stack and/or to detect the number of objects for forming the stack. Different stacking states of the stack have influence on the processing mode of the stack and the processing result; and therefore, in order to obtain an accurate processing result, stacking state information of the stack needs to be determined.

### SUMMARY

The present disclosure provides a data processing method, apparatus and system, a medium and a computer device.

According to a first aspect of embodiments of the present disclosure, a data processing method is provided and includes: obtaining a top view image of a stack, wherein the stack includes at least one object and is formed by stacking the at least one object; performing target detection on the top view image to obtain a bounding box of the stack; determining first size information of the stack based on the bounding box of the stack; determining a distinction between the first size information and second size information of one of the at least one object, wherein the second size information of the one of the at least one object is obtained based on a top view image of the one of the at least one object; and determining stacking state information of the stack based on the distinction.

In some embodiments, determining first size information of the stack based on the bounding box of the stack includes: determining size information of the bounding box of the stack as the first size information; wherein the second size information includes: size information of a bounding box of the one of the at least one object, which is obtained by performing target detection on the top view image of the one of the at least one object; and capture of the top view image of the stack and capture of the top view image of the one of the at least one object are based on identical image capture parameters.

In some embodiments, the distinction between the first size information and the second size information includes at least one of: a distinction between a side length of the bounding box of the stack and a side length of the bounding box of the one of the at least one object; a distinction between an area of the bounding box of the stack and an area of the bounding box of the one of the at least one object; or a distinction between a diagonal length of the bounding box of the stack and a diagonal length of the bounding box of the one of the at least one object.

In some embodiments, the stacking state information includes information for characterizing a stacking mode of respective objects for forming the stack.

In some embodiments, the stacking mode includes a spread stacking mode and a standing stacking mode; determining stacking state information of the stack based on the distinction includes: in response to the distinction being greater than a predetermined distinction threshold, determining that the stacking mode of respective objects for forming the stack is the spread stacking mode; and/or in response to the distinction being less than or equal to the predetermined distinction threshold, determining that the stacking mode of respective objects for forming the stack is the standing stacking mode.

In some embodiments, the method further includes: in response to determining that the stacking mode of respective objects for forming the stack is the spread stacking mode, determining a category of respective objects for forming the stack based on the top view image of the stack; and/or in response to determining that the stacking mode of respective objects for forming the stack is the standing stacking mode, determining a category and/or number of objects for forming the stack based on a side view image of the stack.

In some embodiments, the stacking state information includes a degree of overlap of respective objects for forming the stack.

In some embodiments, the method further includes: obtaining a first identification result by identifying, based on the top view image of the stack, a category of respective objects for forming the stack; obtaining a second identification result by identifying, based on a side view image of the stack, the category of respective objects for forming the stack; and fusing the first identification result and the second identification result based on the degree of overlap to obtain the category of respective objects for forming the stack.

In some embodiments, fusing the first identification result and the second identification result based on the degree of overlap includes: determining, based on the degree of overlap, a first weight of the first identification result and a second weight of the second identification result; and performing weighted fusion on the first identification result and the second identification result according to the first weight and the second weight.

In some embodiments, wherein respective objects for forming the stack have the same size and shape.

In some embodiments, the number of stacks being greater than 1; and the method further includes: for each of the stacks, respectively performing following operations including: identifying objects for forming the stack to obtain a category of the one of the at least one object; and determining, based on the category of the one of the at least one object and a pre-constructed correspondence between object category and bounding box size, a size of a bounding box of the one of the at least one object from a plurality of pre-obtained sizes.

In some embodiments, the method further includes: determining a position of the one of the at least one object based on the top view image of the stack, the position of the one of the at least one object corresponding to a size of a bounding box of the one of the at least one object; and selecting, based on the position of the one of the at least one object and a correspondence between the position of the one of the at least one object and the size of the bounding box of the one of the at least one object, the size of the bounding box of the one of the at least one object from a plurality of pre-obtained sizes.

In some embodiments, the stack is a stack of game coins in a play region of a game, the one of the at least one object is a game coin, the top view image of the stack is obtained by imaging the play region with an image capture device above the play region.

According to a second aspect of embodiments of the present disclosure, a data processing apparatus is provided and includes: a first obtaining module, configured to obtain a top view image of a stack, wherein the stack includes at least one object and is formed by stacking the at least one object; a detection module, configured to perform target detection on the top view image to obtain a bounding box of the stack; a first determining module, configured to determine first size information of the stack based on the bounding box of the stack; a second determining module, configured to determine a distinction between the first size information and second size information of one of the at least one object, wherein the second size information of the one of the at least one object is obtained based on a top view image of the one of the at least one object; and a third determining module, configured to determine stacking state information of the stack based on the distinction.

In some embodiments, the first determining module is configured to determine size information of the bounding box of the stack as the first size information; wherein the second size information includes: size information of a bounding box of the one of the at least one object, which is obtained by performing target detection on the top view image of the one of the at least one object; and capture of the top view image of the stack and capture of the top view image of the one of the at least one object are based on identical image capture parameters.

In some embodiments, the distinction between the first size information and the second size information includes at least one of: a distinction between a side length of the bounding box of the stack and a side length of the bounding box of the one of the at least one object; a distinction between an area of the bounding box of the stack and an area of the bounding box of the one of the at least one object; or a distinction between a diagonal length of the bounding box of the stack and a diagonal length of the bounding box of the one of the at least one object.

In some embodiments, the stacking state information includes information for characterizing a stacking mode of respective objects for forming the stack.

In some embodiments, the stacking mode includes a spread stacking mode and a standing stacking mode; the third determining module is configured to: in response to the distinction being greater than a predetermined distinction threshold, determine that the stacking mode of respective objects for forming the stack is the spread stacking mode; and/or in response to the distinction being less than or equal to the predetermined distinction threshold, determine that the stacking mode of respective objects for forming the stack is the standing stacking mode.

In some embodiments, the apparatus further includes: a fourth determining module configured to: in response to determining that the stacking mode of respective objects for forming the stack is the spread stacking mode, determine a category of respective objects for forming the stack based on the top view image of the stack; and/or a fifth determining module configured to: in response to determining that the stacking mode of respective objects for forming the stack is the standing stacking mode, determine a category and/or number of objects for forming the stack based on a side view image of the stack.

In some embodiments, the stacking state information includes a degree of overlap of respective objects for forming the stack.

In some embodiments, the apparatus further includes: a first identifying module, configured to obtain a first identification result by identifying, based on the top view image of the stack, a category of respective objects for forming the stack; a second identifying module, configured to obtain a second identification result by identifying, based on a side view image of the stack, the category of respective objects for forming the stack; and a fusion module, configured to fuse the first identification result and the second identification result based on the degree of overlap to obtain the category of respective objects for forming the stack.

In some embodiments, the fusion module includes: a weight determining unit configured to determine, based on the degree of overlap, a first weight of the first identification result and a second weight of the second identification result; and a fusion unit configured to perform weighted fusion on the first identification result and the second identification result according to the first weight and the second weight.

In some embodiments, wherein respective objects for forming the stack have the same size and shape.

In some embodiments, the number of stacks being greater than 1; and the apparatus further includes: a third identifying unit, configured to: for each of the stacks, respectively perform following operations including: identifying objects for forming the stack to obtain a category of the one of the at least one object; and determining, based on the category of the one of the at least one object and a pre-constructed correspondence between object category and bounding box size, a size of a bounding box of the one of the at least one object from a plurality of pre-obtained sizes.

In some embodiments, the apparatus further includes: a sixth determining unit, configured to determine a position of the one of the at least one subject based on the top view image of the stack, a position of the one of the at least one object corresponding to a size of a bounding box of the one of the at least one object; and a selecting module, configured to select the size of the bounding box of the one of the at least one object from a plurality of pre-obtained sizes based on the position of the one of the at least one object and a correspondence between the position of the one of the at least one object and the size of the bounding box of the one of the at least one object.

In some embodiments, the stack is a stack of game coins in a play region of a game, the one of the at least one object is a game coin, the top view image of the stack is obtained by imaging the play region with an image capture device above the play region.

According to a third aspect of embodiments of the present disclosure, a data processing system is provided and includes: an image capture unit above a play region of a game, configured to capture a top view image of a stack in the paly region, wherein the stack includes at least one object and is formed by stacking the at least one object; a processing unit communicated with the image capture unit and configured to: perform target detection on the top view image to obtain a bounding box of the stack; determine first size information of the stack based on the bounding box of the stack; determine a distinction between the first size information and second size information of one of the at least one object, wherein the second size information of the one of the at least one object is obtained based on a top view image of the one of the at least one object; and determine stacking state information of the stack based on the distinction.

According to a fourth aspect of embodiments of the present disclosure, a computer readable storage medium storing a computer program is provided. When the computer program is executed by a processor, the method as described in any one of the above embodiments is implemented.

According to a fifth aspect of embodiments of the present disclosure, a computer device is provided and includes a memory, a processor and a computer program stored in the memory and executable on the processor, wherein the processor implements the method as described in any one of the above embodiments when executing the computer program.

In embodiments of the present disclosure, a bounding box of a stack is detected from a top view image of the stack, first size information of the stack is determined based on the bounding box of the stack, stacking state information of the stack is determined based on a distinction between the first size information and second size information of a single object. In the data processing method provided by embodiments of the present disclosure, only the top view image of the stack is detected to obtain the bounding box of the stack, and thus the stacking state information of the stack can be determined. Complex identification algorithm is not needed and the processing efficiency is high.

It should be understood that the above general description and the following detailed description are merely exemplary and explanatory and are not limiting of the present disclosure.

### BRIEF DESCRIPTION OF THE DRAWINGS

The figures herein are incorporated in and constitute a part of this specification, which illustrate embodiments consistent with the present disclosure and together with the description serve to explain the technical solutions of the present disclosure.

FIGS. 1A, 1B and 1C are schematic diagrams of a stack in an ideal state, respectively.

FIG. 2 is a flowchart of a data processing method according to an embodiment of the present disclosure.

FIGS. 3A, 3B and 3C are schematic diagrams of an standing stacking mode according to an embodiment of the present disclosure, respectively.

FIGS. 4A, 4B and 4C are schematic diagrams of a spread stacking mode of embodiments of the present disclosure, respectively.

FIG. 5A is a schematic diagram of a bounding box of a single object according to an embodiment of the present disclosure.

FIGS. 5B and 5C are schematic diagrams of a bounding box of a stack according to an embodiment of the present disclosure, respectively.

FIGS. 6A and 6B are schematic diagrams of a manner of determining stacking state information according to an embodiment of the present disclosure, respectively.

FIG. 7 is a block diagram of a data processing apparatus according to an embodiment of the present disclosure.

FIG. 8 is a schematic diagram of a data processing system according to an embodiment of the present disclosure.

FIG. 9 is a schematic structural diagram of a computer device according to an embodiment of the present disclosure.

### DETAILED DESCRIPTION OF THE EMBODIMENTS

Exemplary embodiments will be described in detail herein, examples of which are shown in the accompanying drawings. The following description relates to the drawings, unless otherwise indicated, the same numerals in the different figures represent the same or similar elements. The embodiments described in the following exemplary embodiments do not represent all embodiments consistent with the present disclosure. Rather, they are merely examples of devices and methods consistent with some aspects of the disclosure as detailed in the appended claims.

The terms used in the present disclosure are for the purpose of describing particular embodiments only and are not intended to limit the present disclosure. The singular forms “a,” “said” and “the” used in the present disclosure and the appended claims are also intended to include the majority of forms unless the context clearly indicates other meanings. It should also be understood that the term “and/or” as used herein refers to and includes any or all possible combinations of one or more associated listed items. In addition, the term “at least one” herein means any one of multiple or any combination of at least two of multiple.

It should be understood that although the terms first, second, third, etc. may be used in this disclosure to describe a variety of information, these information should not be limited to these terms. These terms are only used to distinguish information of the same type from each other. For example, without departing from the scope of the present disclosure, the first information may also be referred to as second information, and similarly, the second information may also be referred to as first information. Depending on the context, the word “if” as used herein may be interpreted as “when” or “upon” or “in response to a determination”.

In order to make those skilled in the art better understand the technical solutions in the embodiments of the present disclosure, and make the objects, features and advantages of the embodiments of the present disclosure more apparent, the technical solutions in the embodiments of the present disclosure will be further described in detail below with reference to the accompanying drawings.

In practical applications, it is often necessary to identify a stack, for example, to identify a category of respective objects for forming the stack and/or the number of objects for forming the stack. The stack refers to a body formed by stacking a plurality of objects, and in particular, a single object may also be regarded as a stack. Stacking two objects means that the two objects at least partially overlap. For example, one object rests against the other object, and the two objects together form one stack. The size and/or shape of objects for forming a stack may be the same or different. Each object may be stacked in the same direction or in different directions.

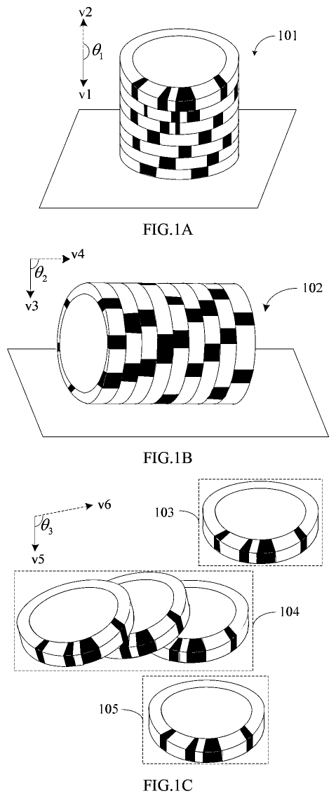

FIG. 1A to FIG. 1C show three different stacking modes in an ideal state, respectively. As shown in FIG. 1A, a plurality of objects are stacked in a vertical direction with a standing stacking mode to form a stack 101. As shown in FIG. 1B, a plurality of objects are stacked in a horizontal direction with a lying stacking mode to form a stack 102. As shown in FIG. 1C, a plurality of objects are stacked with a spread stacking mode to form stacks 103, 104, and 105. It should be noted that, in any one stacking mode, there is at least partial overlap between objects for forming the same stack, and objects not overlapped with each other form different stacks, for example, the objects in three dashed frames shown in FIG. 1C form three different stacks 103, 104 and 105 respectively, and one or more objects in the same dashed frame form the same stack. Although the respective objects for forming the stacks 101 and 102 in FIG. 1A and FIG. 1B completely overlap, the respective objects in the stacks formed by the standing stacking mode or the lying stacking mode may also be partially overlapped. FIG. 1A and FIG. 1B are merely exemplary illustration. A person skilled in the art may understand that, in addition to the three stacking modes described above, one or more objects may form a stack in other modes, for example, a stack can be formed by stacking in other directions than the horizontal direction and the vertical direction, which are not illustrated one by one in the present disclosure.

Referring to FIGS. 1A to 1C, in a case that the viewing angles of the image capture units for capturing a top view image of a stack are the same, for example, the viewing angles of the image capture units are all vertically downward, in top view images of stacks, an included angle between a stacking direction v2 of a stack formed by the standing stacking mode and a viewing angle v1 of an image capture unit for capturing a top view image of the stack is denoted as θ₁; an included angle between a stacking direction v4 of a stack formed by the lying stacking mode and a viewing angle v3 of an image capture unit for capturing a top view image of the stack is denoted as θ₂; and an included angle between a stacking direction v6 of a stack formed by the spread stacking mode and a viewing angle v5 of an image capture unit for capturing a top view image of the stack is denoted as θ₃. θ₁>θ₃>θ₂. In an example, the stack 101 shown in FIG. 1A corresponds to 180 degrees; the stack 102 shown in FIG. 1B corresponds to 90 degrees; and stack 104 shown in FIG. 1C corresponds to an angle between 90 degrees and 180 degrees.

In the case that the viewing angles of the image capture units for capturing a top view image of a stack are the same, for example, the viewing angles of the image capture units are all vertically downward, for a top view image of a stack, if an included angle θ between a stacking direction of the stack in the top view image and a viewing angle of an image capture unit for capturing the top view image of the stack is greater than or equal to a first angle threshold, the stack in the top view image is formed by the standing stacking mode; if θ is less than the first angle threshold and greater than or equal to a second angle threshold, the stack in the top view image is formed by the spread stacking mode; and if θ is less than the second angle threshold, the stack in the top view image is formed by the lying stacking mode. The first angle threshold is greater than or equal to the second angle threshold.

Different stacking states of the stacks have a certain influence on the identification manner and the identification result of the stacks; and therefore, in order to accurately identify a stack, stacking state information of the stack needs to be determined. The stacking state information includes information representing a stacking mode, and can further include information such as an overlap degree, a stacking direction, and an inclination direction between the respective objects in the stacking mode.

In some embodiments, stacks having different stacking states are generally identified in different image identification manners. In the case that a plurality of objects form a stack in the standing stacking mode, the number and category of respective objects for forming the stack are identified based on a side view image of the stack. In the case that a plurality of objects form a stack in the lying stacking mode or the spread stacking mode, the number and/or category of objects for forming the stack are identified based on a top view image of the stack. The side view image can be captured by an image capture unit (such as, a camera) on a side of a plane where the stack is located, and the top view image can be captured by an image capture unit above a plane where the stack is located.

For another example, a degree of overlap and a direction of inclination between objects may affect the accuracy of the identification result. In the case that a plurality of objects form a stack in the standing stacking mode, when a side view image of the stack is taken by the camera, if the stack is inclined, a plurality of objects for forming the stack in the side view image may be obscured from each other, thereby causing an inaccurate identification result. In a case that a plurality of objects form a stack in the spread stacking mode, when a top view image is taken by the camera, with the increase of the overlapping degrees of respective objects for forming the stack, the identification result accuracy based on the top view image is decreased. The more uniform respective objects for forming the stack in the standing stacking mode, the higher the degree of overlap between the objects, and in this case, the higher the degree of confidence of the identification result obtained by identifying the stack through the side view image. The lower the degree of overlap of respective objects for forming the stack in the spread stacking mode, the higher the degree of confidence of the identification result obtained by identifying the stack through the top view image.

In some related technologies, a computer visual depth learning algorithm is used to identify a stack by means of a neural network, so as to determine stacking state information of the stack. For example, the stacking state information can be quantified by identifying a stacking mode of a stack with a neural network, or by determining degrees of overlap between objects for forming the stack through the neural network. However, the processing process of the identification algorithm is long, which leads to low processing efficiency when the stacking state information is determined.

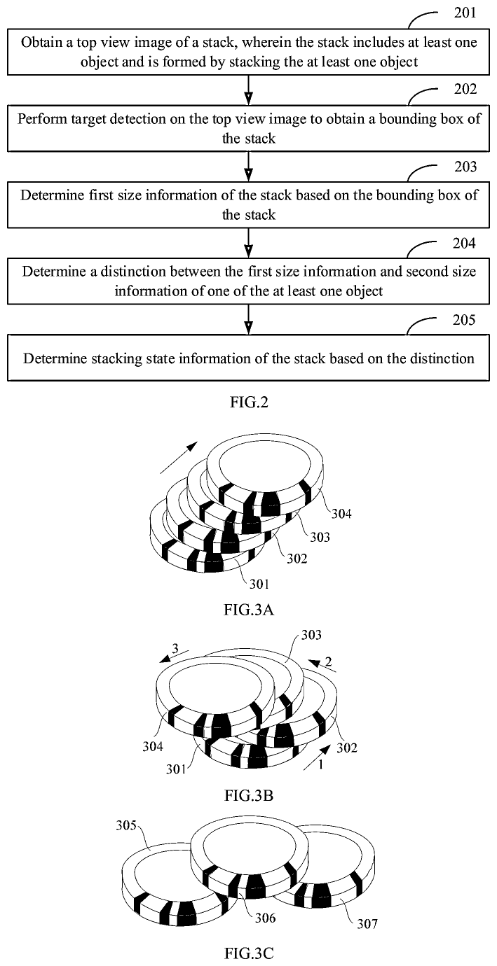

Based on this, embodiments of the present disclosure provide a data processing method, as shown in FIG. 2, the method includes steps 201 to 205.

At step 201, a top view image of a stack is obtained, wherein the stack includes at least one object and is formed by stacking the at least one object.

At step 202, target detection is performed on the top view image to obtain a bounding box of the stack.

At step 203, first size information of the stack is determined based on the bounding box of the stack.

At step 204, a distinction between the first size information and second size information of one of the at least one object is determined, wherein the second size information of the one of the at least one object is obtained based on a top view image of the one of the at least one object.

At step 205, stacking state information of the stack is determined based on the distinction.

In step 201, the top view image of the stack can be obtained by an image capture unit above the stack. Theoretically, the higher the height of the image capture unit is, the more directly facing the stack is, the larger the focal length is, the smaller the degree of perspective deformation of the stack in the top view image taken by the image capture unit is. Therefore, in order to reduce the influence of perspective deformation, the image capture unit may be disposed directly above the stack, the distance between the image capture unit and the stack is set to a value greater than a preset distance, and the focal length of the image capture unit is set to a value greater than a preset focal length.

The stack can include only a single object, or can be formed by stacking at least two objects. Each object for forming the same stack may be an object having the same shape and size, or an object having the same size but different shapes, or an object having different sizes but the same shape, or an object having different sizes and different shapes. For example, the shape of the object presented at the viewing angle in the stacking direction may include, but is not limited to, a circle, an ellipse, a heart, a triangle, a rectangle, a pentagon, a hexagon, etc. In the case that the size and shape of each object are the same, the accuracy of the stacking state information of the stack acquired with manners in embodiments of the present disclosure is high.

The stacking mode in which the respective objects form the stack may include, but is not limited to, the standing stacking mode and the spread stacking mode. In the standing stacking mode, a portion of the objects for forming the stack can contact a plane for placing the stack, and any object for forming the stack at least partially overlaps other objects for forming the stack.

As shown in FIGS. 3A to 3C, there are several schematic diagrams of standing stacking modes. In FIG. 3A, object 301 to object 304 together form a stack. Only the lower surface of object 301 can touch the plane for placing the stack, object 302 partially overlaps object 301, object 303 partially overlaps object 302, object 304 partially overlaps object 303, and the overlap direction of each object is the same, that is, the offset direction of object 302 relative to object 301, the offset direction of object 303 relative to object 302 direction and the offset direction of object 304 with respect to object 303 are the same, and the offset direction is shown by the arrow in FIG. 3A. The stacking mode shown in FIG. 3B differs from the stacking mode shown in FIG. 3A in that in FIG. 3B, the respective objects overlap in different directions, e.g., object 302 partially overlaps object 301 along the direction represented by arrow 1, object 303 partially overlaps object 302 along the direction represented by arrow 2, and object 304 partially overlaps object 303 along the direction represented by arrow 3. In the stacking mode shown in FIG. 3C, object 305, object 306, and object 307 together form a stack. Only the lower surface of object 305 and the lower surface of object 307 can contact the plane for placing the stack, and object 306 partially overlaps on object 305 and object 307.

In the spread stacking mode, the stack is formed by stacking at least two objects; each of the at least two objects can contact the plane for placing the stack, and any one of the objects for forming the stack partially overlaps other objects for forming the stack.

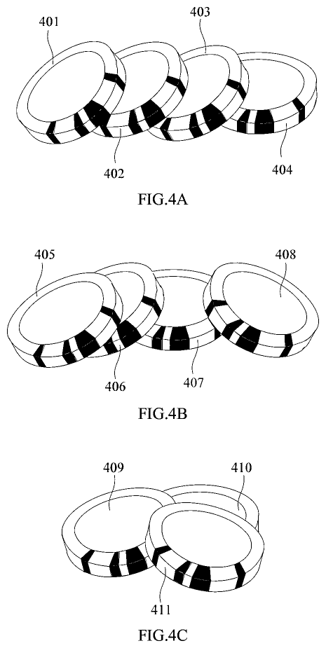

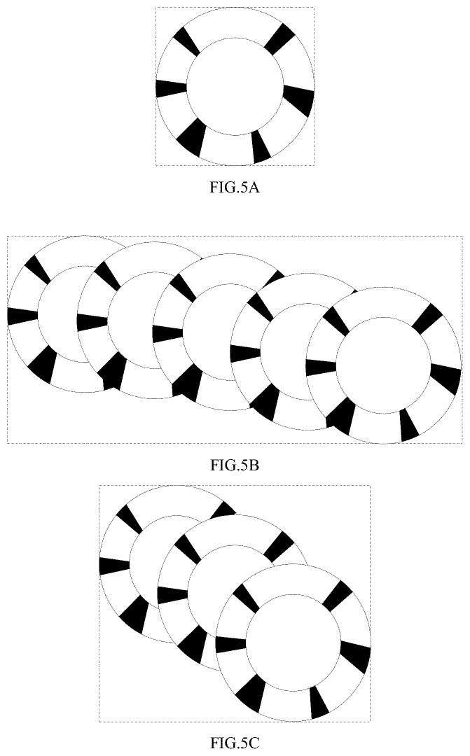

As shown in FIGS. 4A to 4C, there are several schematic diagrams of the spread stacking mode. In FIG. 4A, object 401 to object 404 together form a stack. The lower surface of object 404 can contact a plane for placing the stack, an edge of object 403 can contact the plane for placing the stack, and the lower surface of object 403 partially overlaps the upper surface of object 404. An edge of object 402 can contact the plane for placing the stack and the lower surface of object 402 partially overlaps the upper surface of object 403. An edge of object 401 can contact the plane for placing the stack and the lower surface of object 401 partially overlaps the upper surface of object 402.

In FIG. 4B, object 405 to object 408 together form a stack. The lower surface of object 407 can contact the plane for placing the stack, the edges of object 406 and object 408 can both contact the plane for placing the stack, and the lower surfaces of object 406 and object 408 each partially overlap the upper surface of object 407. The edge of object 405 can contact the plane for placing the stack, and the lower surface of object 405 partially overlaps the upper surface of object 406.

In FIG. 4C, object 409, object 410, and object 411 together form a stack. The lower surface of object 410 can contact the plane for placing the stack, the edge of object 409 can contact the plane for placing the stack, and the lower surface of object 409 partially overlaps the upper surface of object 410. The edge of object 411 can contact the plane for placing the stack, and the lower surface of object 411 partially overlaps the upper surface of object 409 and the upper surface of object 410, respectively.

In addition to the above enumerated cases, the objects in embodiments of the present disclosure may constitute stacks in other manners, which are not exemplified herein. The plane for placing the stack can be a horizontal plane such as a top of a table, the ground, etc., or a plane with an inclination angle, and the present disclosure does not limit this.

In step 202, target detection is performed on the top view image of the stack to obtain the bounding box of the stack. The bounding box of the stack may be a rectangular box that contains the stack, for example, an enclosing box of the stack. One or more stacks may be included in a top view image, each stack is formed by at least one object, and the objects for forming the different stacks have no overlap.

In some embodiments, the bounding boxes of the respective stacks in the top view image may be respectively obtained by a computerized deep learning detection algorithm, or only the bounding boxes of the stacks within a specific region of the top view image may be obtained. Specifically, a region of interest can be determined from the top view image, target detection can be performed on the region of interest, and bounding boxes for stacks within the region of interest can be obtained. The region of interest can be selected in advance, for example, a target region can be selected on the plane where the stack is placed, and then a region corresponding to the target region in the top view image can be determined based on the position of the target region on the plane and extrinsic parameters of the image capture unit for capturing the top view image. The region corresponding to the target region in the top view image is determined as the region of interest.

In step 203, first size information of the stack may be determined based on the bounding box of the stack. For example, actual size information of the stack in physical space may be determined based on the size of the bounding box of the stack and image capture parameters including the focal length of the camera that captured the top view image of the stack, and the actual size information is determined as the first size information. For another example, the size information of the bounding box of the stack can further be directly determined as the first size information.

If the first size information obtained is the actual size information of the stack, in step 204, actual size information of a single object in physical space may be used as the second size information, and the distinction between the first size information and the second size information is determined. If the first size information obtained is the size information of the bounding box of the stack, in step 204, size information of a bounding box of a single object may be used as second size information, and the distinction between the first size information and the second size information is determined. Hereinafter, a solution provided by embodiments of the present disclosure is described with reference to an example in which size information of a bounding box of a stack is determined as first size information, and size information of a bounding box of a single object is taken as second size information.

FIG. 5A is a schematic diagram of a bounding box of a single object. A single object can be placed flat on a plane and a top view image (referred to as top view image P1) of the single object is captured by an image capture unit above the plane. The bounding box of the single object is marked based on the top view image P1 to obtain the size of the bounding box of the single object. In order to reduce the mark error, a plurality of top view images P1 can be captured, and the bounding boxes of the single object are respectively marked based on each top view image P1, and results of the plurality of marks are averaged to obtain the size of the bounding box of the single object. The plurality of top view images P1 are acquired based on the same image capture parameters, i.e., the image capture units to capture the plurality of top view images P1 have the same image capture parameters, or, a plurality of top view images P1 are captured by image capture units with different image capture parameters, and then the plurality of top view images P1 are converted to images corresponding to the same image capture parameters. The image capture parameters may include focal lengths, distortion parameters, postures, etc. of the image capture units.

FIGS. 5B and 5C are respectively a schematic diagram of the bounding box of the stack. It can be seen that the bounding box of the stack includes all objects for forming the stack. Therefore, the number of objects for forming the stack, the stacking mode, the degree of overlap, the stacking direction, etc. all effect the size of the bounding box of the stack.

In the case that the image capture parameters for capturing the top view image of the single object are different from the image capture parameters for capturing the top view image of the stack, even if the actual size of the bounding box of the stack is the same as the actual size of the bounding box of the single object, the size information of the bounding box of the stack may be different from the size information of the bounding box of the single object. Therefore, in order to reduce processing errors due to different image capture parameters, the top view image of the stack and the top view image of the single object can be captured with the same image capture parameters, so that the acquired first size information is comparable to the second size information. In an example, the top view image of the stack and the top view image of the single object can be respectively captured by image capture units with the same image capture parameters. In another example, after the top view image of the stack and the top view image of the single object are respectively captured by image capture units with different image capture parameters, the top view image of the stack and the top view image of the single object can be converted into images corresponding to the same image capture parameters. For example, if the top view image of the stack is captured based on the focal length f1 and the top view image of the single object is captured based on the focal length f2, and f1 is not equal to f2, the top view image of the stack and the top view image of the single object may be converted into images corresponding to a focal length f by an image scaling process or the like. Wherein f can be one of f1 and f2, or other focal length values other than f1 and f2.

Further, since different categories of objects often correspond to different bounding box sizes, in order to improve the accuracy of the determined bounding box size of the single object, it is also possible to identify objects for forming the stack to obtain a category of the one of the at least one object, and based on the category of the one of the at least one object and a pre-constructed correspondence between object category and bounding box size, a size of a bounding box of the one of the at least one object is determined from a plurality of pre-obtained sizes. For example, if a region includes a stack formed by coins and a stack formed by cards, a bounding box size of a single coin is S1 and a bounding box size of a single card is S2, in a case that an object for forming the stack is identified as a coin, S1 is determined as the bounding box size of the single object for forming the stack, and in a case that an object for forming the stack is identified as a card, S2 is determined as the bounding box size of the single object for forming the stack.

In some embodiments, due to the viewing angle, distortion characteristics, etc. of the image capture unit, it may appear that the bounding box of the same object has different sizes when the object is in different positions. In order to improve the accuracy of the size of the bounding box of the single object, the position of the one of the at least one object can be determined based on the top view image of the stack, the position of the one of the at least one object corresponding to the size of the bounding box of the one of the at least one object, and based on the position of the one of the at least one object and a correspondence between the position of the one of the at least one object and the size of the bounding box of the one of the at least one object, the size of the bounding box of the one of the at least one object can be selected from a plurality of pre-obtained sizes. For example, an entire image capture region may be divided into a plurality of sub-regions, and a sub-region in which the one of the at least one object is located is determined based on the position of the one of the at least one object. Assuming that a size of a bounding box of an object corresponding to sub-region 1 is S3 and a size of a bounding box of an object corresponding to sub-region 2 is S4, in a case that an object is detected to be in sub-region 1, S3 is determined as the size of the bounding box of the object, and in a case that an object is detected to be in sub-region 2, S4 is determined as the size of the bounding box of the object.

After obtaining the first size information and the second size information, the distinction between the first size information and the second size information may be determined. The distinction described in this step may include at least one of the following: a distinction between a side length of the bounding box of the stack and a side length of the bounding box of the single object; a distinction between an area of the bounding box of the stack and an area of the bounding box of the single object; a distinction between a diagonal length of the bounding box of the stack and a diagonal length of the bounding box of the single object. The side length may include a length of at least one side of the bounding box, or only the maximum side length of the bounding box is used. For ease of description, hereinafter, the bounding box of the single object is referred to as a standard bounding box and the bounding box of the stack is referred to as an actual bounding box.

In step 205, stacking state information for the stack may be determined based on the distinction between the size of the bounding box of the stack and the size of the bounding box of the single object. The stacking state information includes, but is not limited to, at least any of the following: a stacking mode, a stacking direction, a degree of overlap, a quantity, and a category of an object for forming the stack.

The stacking state information of the stack can be determined based on the distinction in side length, diagonal length or area of the actual bounding box and the standard bounding box. The distinction can be measured by a difference or a ratio of the side lengths, diagonal lengths, or areas. In the case that the distinction is measured by a ratio, distinction in side length θ_{Lr}, distinction in area θ_{Sr}, and distinction in diagonal length θ_{Xr} can be respectively represented as:

$${θ}_{L r} = \frac{L s}{L max} {θ}_{S r} = \sqrt{\frac{L {s}^{2}}{L mas * L min}}$$

$${θ}_{Xr} = \frac{L s x}{L x}$$

In the case of measuring differences by distinctions, distinction in side length θ_{ΔL}, distinction in area θ_{ΔS} and distinction in diagonal length θ_{ΔX} can be respectively represented as:

θ_{ΔL}=L max—Ls

θ_{ΔS}=L max*L min—Ls²

θ_{ΔX}=Lx−Lsx

In above formulas, Ls represents a side length of the standard bounding box, Lmax represents the maximum side length of the actual bounding box, Lmin represents the minimum side length of the actual bounding box, Lsx represents the diagonal length of the standard bounding box, and Lx represents the diagonal length of the actual bounding box.

In some embodiments, in a case that the distinction is greater than a predetermined distinction threshold, it is determined that the respective objects for forming the stack are stacked in the spread stacking mode. In other embodiments, where the distinction is less than or equal to the predetermined distinction threshold, it is determined that the respective objects for forming the stack are stacked in the standing stacking mode. In some embodiments, the predetermined distinction threshold is greater than or equal to two times the standard bounding box size. In other embodiments, the predetermined distinction threshold may also be set to other values.

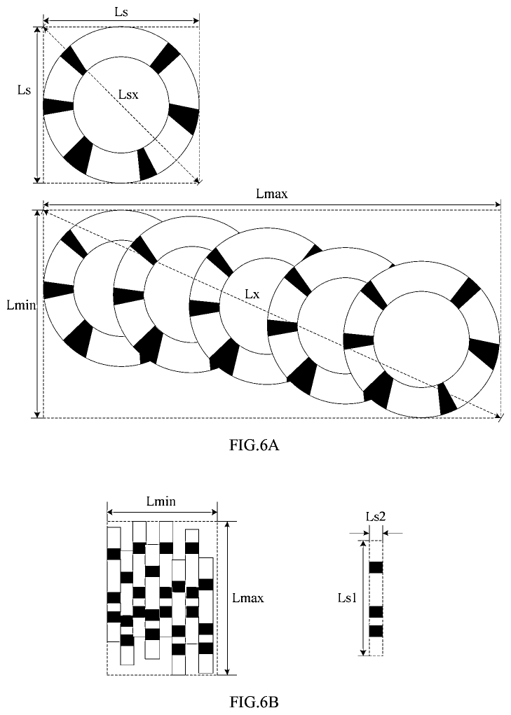

FIGS. 6A and 6B are respectively schematic diagrams of manners of determining stacking state information according to embodiments of the present disclosure. The stack shown in FIG. 6A may be a top view image of a stack in a standing state or a spread state, wherein the shape of the object is a circle, and thus the shape of the standard bounding box is a square, and the length and width of the standard bounding box respectively represent the length and width of a single object, whose values are both Ls, but are not limited to this in practice. To measure the distinction between the standard bounding box and the actual bounding box by the side length, for example, the greater the distinction between the side length of the standard bounding box and the side length of the actual bounding box, the smaller the overlap of the respective objects in the stack; and conversely, the smaller the distinction between the side length of the standard bounding box and the side length of the actual bounding box, the greater the overlap of the respective objects in the stack. If the distinction between the side length of the standard bounding box and the side length of the actual bounding box reaches 2 times the side length of the standard bounding box, it represents that the stack is in the spread state; and if the distinction between the two is less than 2 times the side length of the standard bounding box, it represents that the stack is in the standing state.

FIG. 6B shows a top view image of the stack in the lying state, Ls1 represents the length of the standard bounding box, which represents the length of a single object, and Ls2 represents the width of the standard bounding box, which represents the thickness of a single object. For a sheet-shaped stack, the thickness is generally much smaller than the side length. A length of a side of the actual bounding box parallel to Ls' is noted as Lmax. If the distinction between Lmax and Ls1 is larger, the degree of overlap of respective objects in the stack is smaller; and conversely, the distinction between Lmax and Ls' is smaller, the degree of overlap of respective objects in the stack is larger. If the distinction between Lmax and Ls1 is greater, it represents a greater number of objects in the stack; and conversely, if the distinction between Lmax and Ls1 is smaller, it represents a smaller number of objects in the stack.

In some embodiments, in a case that the stack is formed in the spread stacking mode, a category of respective objects for forming the stack can be determined based on the top view image of the stack. In other embodiments, in a case that the stack is formed in the standing stacking mode, the number and categories of objects for forming the stack can be determined based on a side view image of the stack. In other embodiments, in a case that the stack is formed in the lying mode, the categories and number of objects for forming the stack can be determined based on the top view image of the stack. In other words, different processing logic can be applied to the stacks in different stacking states. The different processing logic can be encapsulated in different processing modules, and with this embodiment, it is possible to invoke the processing module that matches the stacking mode of the stack to process the stack.

In some embodiments, the categories of the respective objects for forming the stack can be identified based on the top view image of the stack to obtain a first identification result; the categories of the respective objects for forming the stack can be identified based on the side view image of the stack to obtain a second identification result; and the first identification result and the second identification result can be fused based on the degree of overlap to obtain the categories of the respective objects for forming the stack.

For example, in a case that the degree of overlap is greater than a predetermined overlap degree threshold, the category of each object for forming the stack can be determined based on the second identification result; and in a case that the degree of overlap is less than or equal to the predetermined overlap degree threshold, the category of each object for forming the stack can be determined based on the first identification result. In another example, a first weight of the first identification result and a second weight of the second identification result can be determined based on the degree of overlap, and the first identification result and the second identification result are respectively weighted based on the first weight and the second weight. The weighted fusion process enables to improve the accuracy of the category identification.

In embodiments of the present disclosure embodiment, a bounding box of a stack is detected from a top view image of the stack, first size information of the stack is determined based on the bounding box of the stack, stacking state information of the stack is determined based on a distinction between the first size information and second size information of a single object. In the data processing method, because only the top view image of the stack is detected, the stacking state information of the stack can be determined, and thus the processing complexity is low. In addition, in embodiments of the present disclosure, it is only necessary to perform target detection on the top view image of the stack and the top view image of the single object, identification algorithms are not needed, the demand for computing power and hardware is low, thus reducing the processing cost for determining the stacking state information. In addition, because the target detection process is less time-consuming, the processing efficiency can be improved.

In addition, the solutions in embodiments of the present disclosure have the following advantages.

(1) In embodiments of the present disclosure, an image from a top viewing angle is used to determine stacking state information of the stack, thereby reducing processing complexity.

(2) In embodiments of the present disclosure, only the detection algorithm is used to detect the bounding box of the stack to determine the stacking state information of the stack, thereby realizing low complexity and high efficiency processing.

(3) In embodiments of the present disclosure, data does not need to be labelled, thereby reducing processing complexity and saving labeling costs.

(4) Compared with a case that quantitative information, such as the overlap degree of objects for forming the stack with the standing state, the overlap degree of objects for forming the stack with the spread state, and so on, cannot be described, or a large amount of labeled data is needed to obtain the above information in related technologies, in embodiments of the present disclosure, the distinction between the standard bounding box and the actual bounding box can be used to determine various quantitative information.

Embodiments of the present disclosure can be applied in a game scenario in which the stack is a stack of game coins in a play region of a game, and a single object for forming the stack is game coin, and the game coins are used for counting during the game. The top view image of the stack can be obtained by imaging the play region with an image capture device above the play region.

The placement of game coins in the play region need to determine the stacking mode of game coins. The different stacking modes have different roles during the game. For example, game coins in the standing state are used to place bets and game coins in the spread state are used to show the number of game coins in a stack. The different stacking states of game coins are used as identifiers to trigger different processing logic. In addition, in addition to the need to distinguish the stacking state of game coins in the game itself, when the computer identifies the stack of game coins, the degree of verticality, the degree of inclination of the stack or the degree of stacking in the spread mode all have an impact on the identification. For example, when it is needed to identify game coins in a stack, if the stack is inclined, the side view image of the stack will be obscured, resulting in inaccurate identification. In general, the stacking mode of the game coins in the play region needs to be determined, and the game coins in the play region are generally in the standing state or the spread state.

Since game coins of the same category are of equal shape and size, the top view image of the stack can be used to determine the stacking mode. A size of s bounding box of a flatly placed game coin determined by the computer vision detection algorithm can be used as a “standard size” of the bounding box. The size of the bounding box of a stack of game coins in the top view image is compared with the “standard size” to get the uniformity information. When the height and focal length of the camera for obtaining the standard size are the same as the height and focal length of the camera for obtaining the stack, the “straighter” the stack is, the smaller the bounding box size of the stack is, and the closer it is to the “standard size”, the higher the coincidence/overlap degree of the game coins in the stack is when viewed from the top. The difference or ratio of the bounding box size can be used as a quantitative value to measure of the coincidence/overlap degree of the game coins in the stack.

The above data processing method is common to both the standing state and the spread state, where when the degree of overlap is greater than or equal to a threshold, the stacking state of the stack is the standing state, and when the degree of overlap is less than the threshold, the stacking state of the stack is the spread state. The threshold is set empirically. The spread state can be considered as a state where the game coins in the standing are excessively inclined. In the standing state, the degree of overlap can be used to describe the uniformity degree of game coin placement, and the higher the degree of overlap, the more uniform it is. In the spread state, the degree of overlap can be used to describe the spread degree of the game coins, and the lower the degree of overlap, the more spread out the game coins are.

Due to the limitation of the bounding box direction, the direction of the side of the bounding box may not follow the spread direction of the game coins, but this does not affect the rule that the bounding box size of the stack becomes larger with the dispersion of the spread. If the game coins are spread to separation, the detection algorithm will detect two stacks. Therefore, by comparing the size of the bounding box of the stack with the “standard size”, the quantitative value to measure the overlap degree and inclination degree of game coins in the stack can be obtained.

The above method requires only the detection algorithm and the top view image to obtain various quantitative information about the stack through simple arithmetic operations. The above method can also be applied in poker-type games with small cost and fast speed, which can effectively solve the problem of algorithm detection and identification accuracy in actual games. The above method is simple in logic but strong in constraints, easy to implement and high in accuracy, and high in versatility, and with the above method, the posture, uniformity degree, inclination degree, spread degree, etc. of the stack can be determined through the quantization value.

It can be understood by those skilled in the art that in the above methods of the detailed description, the order in which the steps are written does not imply a strict order of execution and does not constitute any limitation to the implementation process, and the specific order of execution of each step should be determined by its function and possible intrinsic logic.

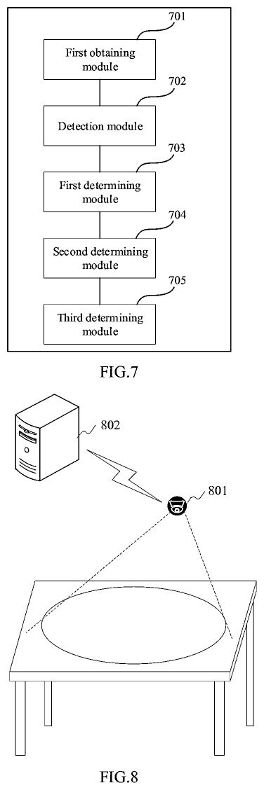

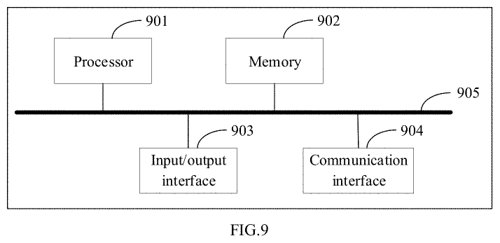

As shown in FIG. 7, the present disclosure further provides a data processing apparatus, the apparatus includes:

a first obtaining module 701, configured to obtain a top view image of a stack, wherein the stack includes at least one object and is formed by stacking the at least one object;

a detection module 702, configured to perform target detection on the top view image to obtain a bounding box of the stack;

a first determining module 703, configured to determine first size information of the stack based on the bounding box of the stack;

a second determining module 704, configured to determine a distinction between the first size information and second size information of one of the at least one object, wherein the second size information of the one of the at least one object is obtained based on a top view image of the one of the at least one object;

a third determining module 705, configured to determine stacking state information of the stack based on the distinction.

In some embodiments, the first determining module is configured to determine size information of the bounding box of the stack as the first size information; wherein the second size information includes: size information of a bounding box of the one of the at least one object, which is obtained by performing target detection on the top view image of the one of the at least one object; and capture of the top view image of the stack and capture of the top view image of the one of the at least one object are based on identical image capture parameters.

In some embodiments, the distinction between the first size information and the second size information includes at least one of: a distinction between a side length of the bounding box of the stack and a side length of the bounding box of the one of the at least one object; a distinction between an area of the bounding box of the stack and an area of the bounding box of the one of the at least one object; or a distinction between a diagonal length of the bounding box of the stack and a diagonal length of the bounding box of the one of the at least one object.

In some embodiments, the stacking state information includes information for characterizing a stacking mode of respective objects for forming the stack.

In some embodiments, the stacking mode includes a spread stacking mode and a standing stacking mode; the third determining module is configured to: in response to the distinction being greater than a predetermined distinction threshold, determine that the stacking mode of respective objects for forming the stack is the spread stacking mode; and/or in response to the distinction being less than or equal to the predetermined distinction threshold, determine that the stacking mode of respective objects for forming the stack is the standing stacking mode.

In some embodiments, the apparatus further includes: a fourth determining module configured to: in response to determining that the stacking mode of respective objects for forming the stack is the spread stacking mode, determine a category of respective objects for forming the stack based on the top view image of the stack; and/or a fifth determining module configured to: in response to determining that the stacking mode of respective objects for forming the stack is the standing stacking mode, determine a category and/or number of objects for forming the stack based on a side view image of the stack.

In some embodiments, the stacking state information includes a degree of overlap of respective objects for forming the stack.

In some embodiments, the apparatus further includes: a first identifying module, configured to obtain a first identification result by identifying, based on the top view image of the stack, a category of respective objects for forming the stack; a second identifying module, configured to obtain a second identification result by identifying, based on a side view image of the stack, the category of respective objects for forming the stack; and a fusion module, configured to fuse the first identification result and the second identification result based on the degree of overlap to obtain the category of respective objects for forming the stack.

In some embodiments, the fusion module includes: a weight determining unit configured to determine, based on the degree of overlap, a first weight of the first identification result and a second weight of the second identification result; and a fusion unit configured to perform weighted fusion on the first identification result and the second identification result according to the first weight and the second weight.

In some embodiments, wherein respective objects for forming the stack have the same size and shape.

In some embodiments, the number of stacks being greater than 1; and the apparatus further includes: a third identifying unit, configured to: for each of the stacks, respectively perform following operations including: identifying objects for forming the stack to obtain a category of the one of the at least one object; and determining, based on the category of the one of the at least one object and a pre-constructed correspondence between object category and bounding box size, a size of a bounding box of the one of the at least one object from a plurality of pre-obtained sizes.

In some embodiments, the apparatus further includes: a sixth determining unit, configured to determine a position of the one of the at least one subject based on the top view image of the stack, a position of the one of the at least one object corresponding to a size of a bounding box of the one of the at least one object; and a selecting module, configured to select the size of the bounding box of the one of the at least one object from a plurality of pre-obtained sizes based on the position of the one of the at least one object and a correspondence between the position of the one of the at least one object and the size of the bounding box of the one of the at least one object.

In some embodiments, the stack is a stack of game coins in a play region of a game, the one of the at least one object is a game coin, the top view image of the stack is obtained by imaging the play region with an image capture device above the play region.

In some embodiments, the functions or the included modules of the apparatus provided in the embodiments of the present disclosure may be configured to execute the method described in the above method embodiments. For specific implementation, reference may be made to the description of the above method embodiments. For brevity, details are not described herein again.

As shown in FIG. 8, the present disclosure further provides a data processing system, the system includes:

an image capture unit 801 above a play region of a game, configured to capture a top view image of a stack in the paly region, wherein the stack comprises at least one object and is formed by stacking the at least one object;

a processing unit 802 communicated with the image capture unit 801 and configured to:

perform target detection on the top view image to obtain a bounding box of the stack;

determine first size information of the stack based on the bounding box of the stack;

determine a distinction between the first size information and second size information of one of the at least one object, wherein the second size information of the one of the at least one object is obtained based on a top view image of the one of the at least one object; and

determine stacking state information of the stack based on the distinction.

The play region in embodiments of the present disclosure may be as shown in the gray region in FIG. 8, and the play region is a partial region on a table. The image capture unit 801 may be a device having an image capture function such as a camera disposed directly above the game region. By disposing the image capture unit 801 directly above the play region, on the one hand, the field of image range of the image capture unit 801 can be covered to the entire play region as much as possible, and on the other hand, the perspective distortion due to the angle inclination can be reduced. The processing unit 802 can communicate with the image capturing unit 801 in a wired or wireless manner, and the processing unit 802 may be a single processor or a processor cluster including a plurality of processors. The processing unit 802 may perform the data processing method according to any embodiment of the present disclosure to obtain stack state information of the stack in the play region.

Embodiments of the present description further provide a computer device including at least a memory, a processor and a computer program stored in the memory and executable on the processor, wherein the processor implements the method according to any one of the above embodiments when executing the program.

FIG. 9 shows a schematic diagram of a hardware structure of a computing device provided by an embodiment of the present description. The computing device may include a processor 901, a memory 902, an input/output interface 903, a communication interface 904, and a bus 905. The processor 901, the memory 902, the input/output interface 903, and the communication interface 904 implement a communication connection between each other inside the device through the bus 905.

The processor 901 may be implemented by using a common Central Processing Unit (CPU), a microprocessor, an Application Specific Integrated Circuit (ASIC), or one or more integrated circuits, etc. The processor 901 is configured to execute relevant programs to implement the technical solutions provided by the embodiments of the present description. The processor 901 may further include a display card, and the display card may be an Nvidia titan X display card or a 1080 Ti display card.

The memory 902 may be implemented in the form of a Read Only Memory (ROM), a Random Access Memory (RAM), a static storage device, a dynamic storage device, and the like. The memory 902 may store an operating system and other application programs, and when the technical solutions provided by the embodiments of the present description are implemented by software or firmware, the relevant program code is stored in the memory 902, and the execution is invoked by the processor 901.

The input/output interface 903 is configured to connect the input/output module to realize information input and output. The input/output module (not shown in FIG. 9) may be configured in a device as a component, and may also be external to the device to provide corresponding functions. The input device may include a keyboard, a mouse, a touch screen, a microphone, various types of sensors, etc., and the output device may include a display, a speaker, a vibrator, an indicator, etc.

The communication interface 904 is configured to connect to a communication module (not shown in FIG. 9) to implement communication interaction between the device and other devices. The communication module may implement communication in a wired manner (for example, USB, network wire, etc.), and may also implement communication in a wireless manner (for example, mobile network, WIFI, Bluetooth, etc.).

The bus 905 includes a path for communicating information between various components of the device (e. g., the processor 901, the memory 902, the input/output interface 903, and the communication interface 904).

It should be noted that, although the device merely shows the processor 901, the memory 902, the input/output interface 903, the communication interface 904, and the bus 905, in a specific implementation process, the device can further include other components necessary to implement normal operation. In addition, a person skilled in the art may understand that the device may also include only components necessary for implementing the embodiments of the present description, and not necessarily include all components shown in FIG. 9.

Embodiments of the present disclosure further provide a computer readable storage medium, in which a computer program is stored, and the computer program is executed by a processor to implement the method described in any one of the above embodiments.

Computer-readable storage media include permanent and non-permanent, removable and non-removable media, and may use any method or technology for information storage. The information may be computer readable instructions, data structures, modules of programs, or other data. Examples of storage media of a computer include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory body or other memory technology, read-only optical disk read-only memory (CD-ROM), digital versatile disc (DVD) or other optical storage, magnetic cassette, a magnetic tape disk storage or other magnetic storage device or any other non-transmission medium that can be used to store information that can be accessed by the computing device. According to the definitions herein, the computer readable medium does not include a transitory computer readable medium, such as a modulated data signal and carrier wave.

Embodiments of the present disclosure further provide a computer program stored in a storage medium, when the computer program is executed by a processor, the method described in any one of the above embodiments is implemented.

It can be seen from the description of the above embodiments that a person skilled in the art can clearly understand that the embodiments of the present description can be implemented by means of software plus necessary general hardware platform. Based on such understanding, the technical solutions of the embodiments of the present description essentially or the part contributing to the prior art may be embodied in the form of a software product. The computer software product may be stored in a storage medium, such as, a ROM/RAM, a magnetic disk, an optical disk, and the like and including several instructions for enabling a computer device (which may be a personal computer, a server, or a network device, etc.) to execute the method described in each embodiment or some part of the embodiments of the present description.

The system, apparatus, module or unit set forth in the above embodiments may be specifically implemented by a computer chip or an entity, or implemented by a product having a certain function. A typical implementation device is a computer, and a specific form of the computer may include a personal computer, a laptop computer, a cellular phone, a camera phone, a smart phone, a personal digital assistant, a media player, a navigation device, an e-mail transceiver device, a game console, a tablet computer, a wearable device, or a combination of any of these devices.

Various embodiments in the present description are described in a progressive manner, parts similar to each other between various embodiments can be referred to for each other, and each embodiment focuses on the differences from other embodiments. Especially, for the apparatus embodiment, since the apparatus is basically similar to the method embodiment, the description is simplified, and reference may be made to some of the description of the method embodiment. The apparatus embodiments described above are merely schematic, in which the modules described as separate components may or may not be physically separated, and the functions of the modules may be implemented in one or more software and/or hardware when the embodiments of the present description are implemented. Alternatively, some or all of the modules may be selected according to actual needs to achieve the purpose of the solution of this embodiment. A person of ordinary skill in the art would understand and implement without inventive efforts.

1. A data processing method, comprising:
obtaining a top view image of a stack, wherein the stack comprises at least one object and is formed by stacking the at least one object;
performing target detection on the top view image to obtain a bounding box of the stack;
determining first size information of the stack based on the bounding box of the stack;
determining a distinction between the first size information and second size information of one of the at least one object, wherein the second size information of the one of the at least one object is obtained based on a top view image of the one of the at least one object; and
determining stacking state information of the stack based on the distinction.

2. The method according to claim 1, wherein determining first size information of the stack based on the bounding box of the stack comprises:
determining size information of the bounding box of the stack as the first size information;
wherein the second size information comprises: size information of a bounding box of the one of the at least one object, which is obtained by performing target detection on the top view image of the one of the at least one object; and
capture of the top view image of the stack and capture of the top view image of the one of the at least one object are based on identical image capture parameters.

3. The method according to claim 2, wherein the distinction between the first size information and the second size information comprises at least one of:
a distinction between a side length of the bounding box of the stack and a side length of the bounding box of the one of the at least one object;
a distinction between an area of the bounding box of the stack and an area of the bounding box of the one of the at least one object; or
a distinction between a diagonal length of the bounding box of the stack and a diagonal length of the bounding box of the one of the at least one object.

4. The method according to claim 1, wherein the stacking state information comprises information for characterizing a stacking mode of respective objects for forming the stack.

5. The method according to claim 4, wherein the stacking mode comprises a spread stacking mode and a standing stacking mode; determining stacking state information of the stack based on the distinction comprises:
in response to the distinction being greater than a predetermined distinction threshold, determining that the stacking mode of respective objects for forming the stack is the spread stacking mode; and/or
in response to the distinction being less than or equal to the predetermined distinction threshold, determining that the stacking mode of respective objects for forming the stack is the standing stacking mode.

6. The method according to claim 5, further comprising:
in response to determining that the stacking mode of respective objects for forming the stack is the spread stacking mode, determining a category of respective objects for forming the stack based on the top view image of the stack; and/or
in response to determining that the stacking mode of respective objects for forming the stack is the standing stacking mode, determining a category and/or number of objects for forming the stack based on a side view image of the stack.

7. The method according to claim 1, wherein the stacking state information comprises a degree of overlap of respective objects for forming the stack.

8. The method according to claim 7, further comprising:
obtaining a first identification result by identifying, based on the top view image of the stack, a category of respective objects for forming the stack;
obtaining a second identification result by identifying, based on a side view image of the stack, the category of respective objects for forming the stack; and
fusing the first identification result and the second identification result based on the degree of overlap to obtain the category of respective objects for forming the stack.

9. The method according to claim 8, wherein fusing the first identification result and the second identification result based on the degree of overlap comprises:
determining, based on the degree of overlap, a first weight of the first identification result and a second weight of the second identification result; and
performing weighted fusion on the first identification result and the second identification result according to the first weight and the second weight.

10. The method according to claim 1, wherein respective objects for forming the stack have the same size and shape.

11. The method according to claim 1, wherein the number of stacks being greater than 1; and the method further comprises:
for each of the stacks, respectively performing following operations comprising:
identifying objects for forming the stack to obtain a category of the one of the at least one object; and
determining, based on the category of the one of the at least one object and a pre-constructed correspondence between object category and bounding box size, a size of a bounding box of the one of the at least one object from a plurality of pre-obtained sizes.

12. The method according to claim 1, further comprising:
determining a position of the one of the at least one subject based on the top view image of the stack, the position of the one of the at least one object corresponding to a size of a bounding box of the one of the at least one object; and
selecting, based on the position of the one of the at least one object and a correspondence between the position of the one of the at least one object and the size of the bounding box of the one of the at least one object, the size of the bounding box of the one of the at least one object from a plurality of pre-obtained sizes.

13. The method according to claim 1, wherein the stack is a stack of game coins in a play region of a game, the one of the at least one object is a game coin, the top view image of the stack is obtained by imaging the play region with an image capture device above the play region.

14. A non-transitory computer readable storage medium storing a computer program, when the computer program is executed by a processor, the processor is caused to perform operations comprising:
obtaining a top view image of a stack, wherein the stack comprises at least one object and is formed by stacking the at least one object;
performing target detection on the top view image to obtain a bounding box of the stack;
determining first size information of the stack based on the bounding box of the stack;
determining a distinction between the first size information and second size information of one of the at least one object, wherein the second size information of the one of the at least one object is obtained based on a top view image of the one of the at least one object; and
determining stacking state information of the stack based on the distinction.

15. A computer device, comprising a memory, a processor and a computer program stored in the memory and executable on the processor, wherein when the computer is executed by a processor, the processor is caused to perform operations comprising:
obtaining a top view image of a stack, wherein the stack comprises at least one object and is formed by stacking the at least one object;
performing target detection on the top view image to obtain a bounding box of the stack;
determining first size information of the stack based on the bounding box of the stack;
determining a distinction between the first size information and second size information of one of the at least one object, wherein the second size information of the one of the at least one object is obtained based on a top view image of the one of the at least one object; and
determining stacking state information of the stack based on the distinction.

16. The computer device according to claim 15, wherein determining first size information of the stack based on the bounding box of the stack comprises:
determining size information of the bounding box of the stack as the first size information;
wherein the second size information comprises: size information of a bounding box of the one of the at least one object, which is obtained by performing target detection on the top view image of the one of the at least one object; and
capture of the top view image of the stack and capture of the top view image of the one of the at least one object are based on identical image capture parameters.

17. The computer device according to claim 16, wherein the distinction between the first size information and the second size information comprises at least one of:
a distinction between a side length of the bounding box of the stack and a side length of the bounding box of the one of the at least one object;
a distinction between an area of the bounding box of the stack and an area of the bounding box of the one of the at least one object; or
a distinction between a diagonal length of the bounding box of the stack and a diagonal length of the bounding box of the one of the at least one object.

18. The computer device according to claim 15, wherein the stacking state information comprises information for characterizing a stacking mode of respective objects for forming the stack.

19. The computer device according to claim 18, wherein the stacking mode comprises a spread stacking mode and a standing stacking mode; determining stacking state information of the stack based on the distinction comprises:
in response to the distinction being greater than a predetermined distinction threshold, determining that the stacking mode of respective objects for forming the stack is the spread stacking mode; and/or
in response to the distinction being less than or equal to the predetermined distinction threshold, determining that the stacking mode of respective objects for forming the stack is the standing stacking mode.

20. The computer device according to claim 19, wherein the operations further comprising:
in response to determining that the stacking mode of respective objects for forming the stack is the spread stacking mode, determining a category of respective objects for forming the stack based on the top view image of the stack; and/or
in response to determining that the stacking mode of respective objects for forming the stack is the standing stacking mode, determining a category and/or number of objects for forming the stack based on a side view image of the stack.
